(19) United States
(12) Patent Application Publication
(10) Pub. No.: US 2011/0247924 A1
(43) Pub. Date: Oct. 13, 2011

(54) KEY BUTTON MECHANISM AND ELECTRONIC DEVICE USING THE SAME

(75) Inventor: GUANG-FEI CAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/789,603

(22) Filed: May 28, 2010

(30) Foreign Application Priority Data
Apr. 13, 2010 (CN) 201020157029.8

(51) Int. Cl. H01H 3/00

(52) U.S. Cl. 200/329

(57) ABSTRACT

A key button structure for entering data in an electronic device comprises a first key element and a second key element. The second key element is retained to the first key element by a retaining mechanism. The second key element has a joint positioned at a side thereof opposite to the first key element and two actuators 226 located at an opposite side thereof facing the first key element. The joint pivotably couples the second key element to a housing 10 of the electronic device.

### BACKGROUND

1. Technical Field

This disclosure relates to key button mechanisms, particularly to key button mechanisms used in a portable electronic device.

2. Description of Related Art

Many portable electronic devices such as mobile phones, have housings with an interior compartment for receiving a printed circuit board (PCB) therein. The mobile phones usually include a side key assembly on an outer sidewall of the housing, so that user can operate the mobile phone with just one finger. However, if a slight gap is formed between the side key assembly and the housing, water and/or vapor could penetrate through the gap into the portable electronic device, affecting the circuit board.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary housing and method making the housing. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary key button mechanism.

FIG. 2 is another exploded view of the key button mechanism shown in FIG. 1, but showing the key button mechanism in another aspect.

FIG. 3 is an assembled view of the key button mechanism shown in FIG. 1.

FIG. 4 is a cross sectional view of the key button mechanism shown in FIG. 3.

FIG. 5 is a cross sectional view of another exemplary key button mechanism.

### DETAILED DESCRIPTION

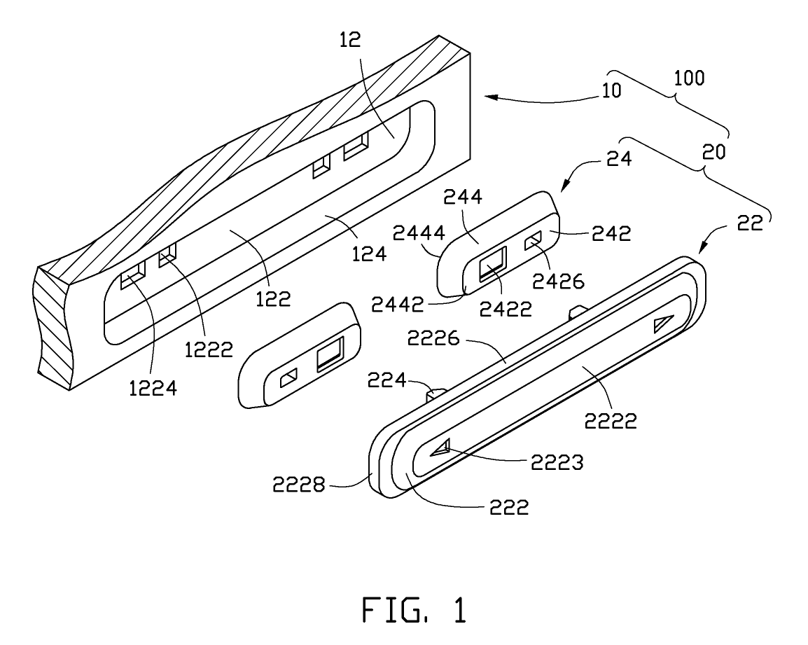

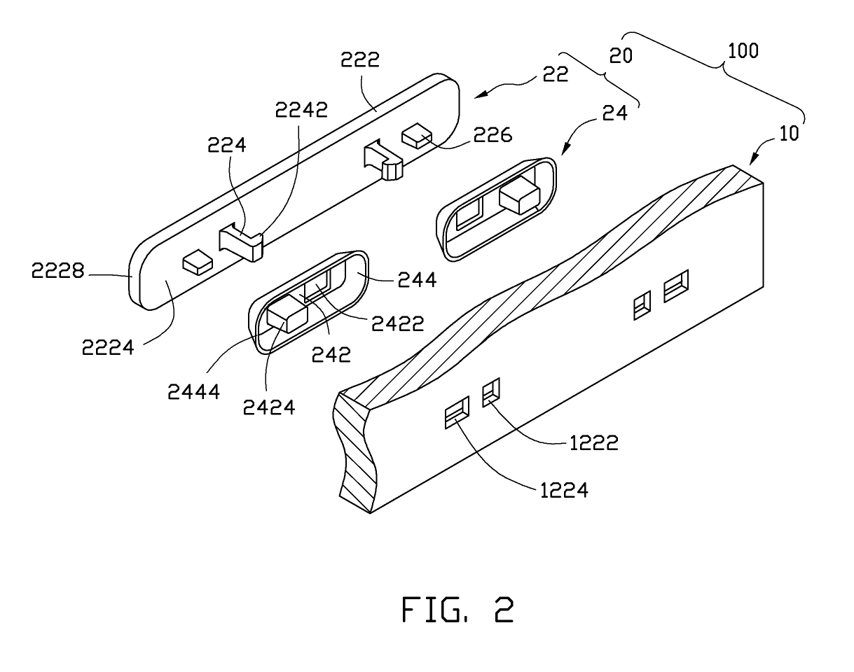

An embodiment of an electronic device 100 incorporating a key button mechanism 20 is shown in FIG. 1 and FIG. 2. FIG. 1 illustrates an exploded view of the key button mechanism 10. FIG. 2 illustrates another exploded view of the key button mechanism 10.

The exemplary device 100, which may be a mobile phone in this case, includes a housing 10 and the key button mechanism 20. The housing 10 includes a receptacle 12 recessed from an outer surface thereof. The receptacle 12 is configured to accommodate the key button mechanism 20.

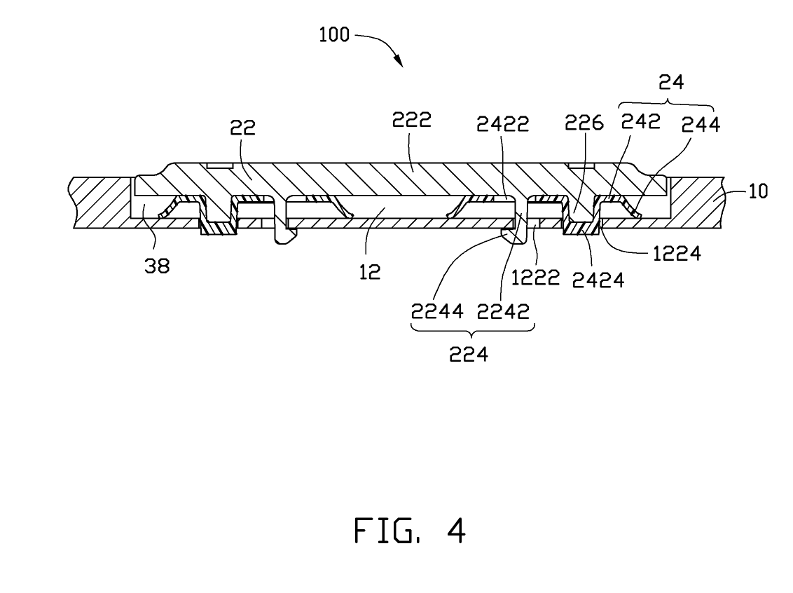

The key button mechanism 20 includes a key body 22 and one or more hermetic elements 24 mounted to the key body 22. The key body 22, in this embodiment, is complementary in shape to, but slightly smaller than, the receptacle 12 of the housing 10. The key body 22 is movably accommodated in the receptacle 12 of the housing 10. The key button mechanism 20 further includes one or more indentations 2223 positioned spacedly on an outside surface 2222 of the key body 22, and one or more actuators 226 spacedly protruding from an inner surface 2224 of the key body 22. The actuators 226 correspond to the indentations 2223, respectively. The housing 10 further has one or more openings 1224 defined in a bottom wall of the receptacle 12 and corresponding to the actuators 226. When the key body 22 is accommodated in the receptacle 12 of the housing 10 like shown in FIG. 4, the actuators 226 are respectively aligned with the openings 1224 of the housing 10.

A user can apply manual force to the indentations 2223 of the key body 22 to cause the actuators 226 of the key body 22 to slide toward the openings 1224 of the housing 10 until the actuators 226 pass through the openings 1224, thus a printed circuit board (not shown) in the housing 10 is actuated.

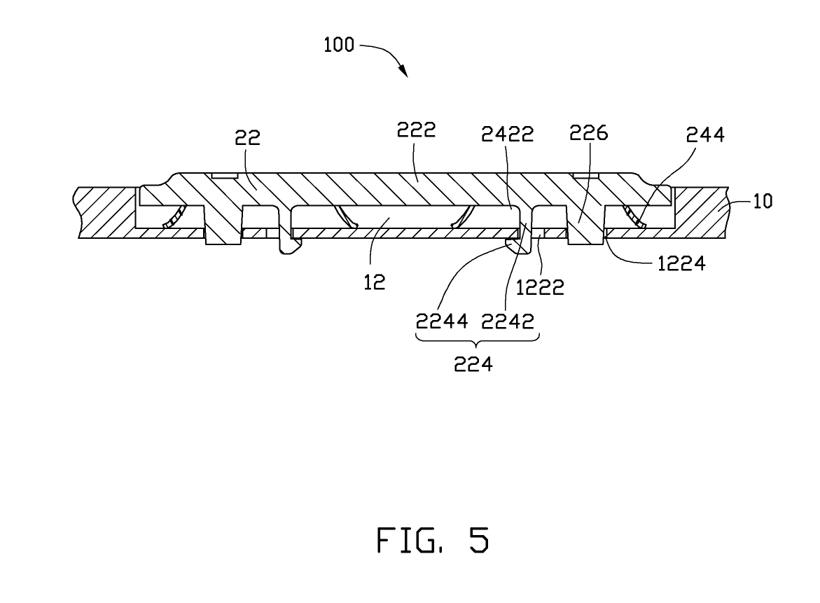

Each hermetic element 24 includes a planar board 242 and a tubular member 244 located surrounding the edge of the planar board 242. The tubular member 244 is hermetically coupled between the key body 22 and the housing 10 such that liquid matter (e.g., water) can not penetrate a gap 38 (see FIG. 4) formed between the key body 22 and the housing 10. The tubular member 244 has a first end portion 2442 and a second end portion 2444 that is larger than the first end portion 2442. In this embodiment, the planar board 242 is hermetically positioned on the inner surface 2224 of the key body 22, the first end portion 2442 is hermetically positioned or protruding from the planar board 242, and the second end portion 2444 is hermetically mounted to the bottom wall of the receptacle 12 of the housing 10. The planar board 242 further has a mounting portion 2424 (see FIG. 2) with a slot 2426 (see FIG. 1) recessed therein for accommodating corresponding actuators 226 when the planar board 242 is mounted to the key body 22. It is understood to one of ordinary skill in the art that the planar board 242 may be positioned on either the key body 22 or the housing 10 and the second end portion 2444 of the tubular member 244 may be positioned on the element that the planar board 242 is not positioned on. It is also to be understood that the planar board 242 may be omitted. In this embodiment, the first end portion 2442 of the tubular member 244 is directly mounted to the key body 22 like shown in FIG. 5.

A retaining structure (not labeled) may be employed to assist the key body 22 mounting to the housing 10. The retaining structure is illustrated in FIGS. 2 and 4. The retaining structure includes two spaced-apart troughs 1222 defined through the bottom wall of the receptacle 12 of the housing 10, two retaining members 224 carried on the key body 22 extending into the troughs 1222. A distal end of each retaining member 224 is wider than corresponding trough 1222 such that the retaining members 224 are retained within the troughs 1222 thereby assisting the key body 22 to be retained to the housing 10.

Each planar board 242 further has a hole 2422 aligned with corresponding trough 1222 when the hermetic elements 24 are positioned between the key body 22 and the housing 10. The holes 2422 are configured to allow the retaining members 224 to pass through a corresponding planar board 242, so that the planar board 242 can be located between the housing 10 and the key body 22 when the hermetic elements 24 are carried to the housing 10.

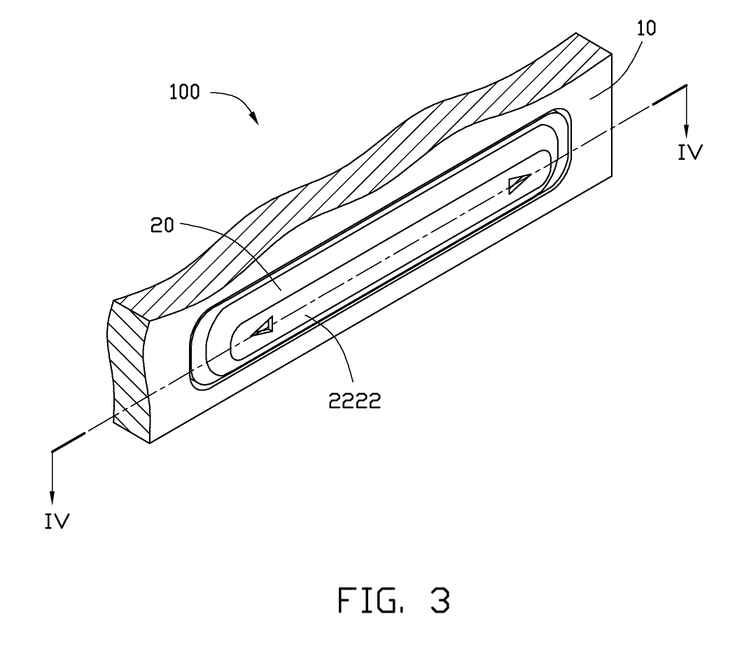

Referring to FIGS. 1-4, in assembly, the second end portions 2444 of the hermetic elements 24 are first hermetically mounted (e.g., hot-melted) to the bottom wall of the receptacle 12 of the housing 10. The mounting portions 2424 are accommodated in corresponding openings 1224 of the housing 10, the holes 2422 of the hermetic elements 24 are aligned with corresponding troughs 1222. The retaining members 224 of the key body 22 are then aligned with corresponding holes 2422 of the hermetic elements 24, and the actuators 226 of the key body 22 are aligned with corresponding slots 2422 of the hermetic elements 24. The key body 22 are then pushed toward the hermetic elements 24, until the retaining members 224 pass through the holes 2422 and the troughs 1222, and the actuators 226 pass through the slots 2426 and mounting portions 2424 to enter the openings 1224. The planar board 242 are then mounted to the inner surface 2224 of the key body 22 by a method such as holt-melted, yielding an assembled device 100.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key button mechanism for entering data in an electronic device, comprising:
a key body having a actuator protruding therefrom; and
a hermetic element mounted to the key body, the hermetic element including a tubular member, the tubular member being configured for hermetically mounted to the key body and surrounding the actuator.

2. The key button mechanism as claimed in claim 1, wherein the tubular member has a first end portion and a second end portion that is larger than the first end portion, the first end portion is sealingly mounted to the key body.

3. The key button mechanism as claimed in claim 1, wherein each hermetic element further includes a planar board hermetically mounted on the key body, the tubular member surrounds the edge of the planar board.

4. The key button mechanism as claimed in claim 3, wherein the planar board has a mounting portion with a slot recessed therein; the actuator is accommodating in the slot when the planar board is mounted to the key body.

5. The key button mechanism as claimed in claim 2, wherein the key body further includes a retaining member protruding therefrom for retaining the key body to the electronic device.

6. An electronic device, comprising:
a housing; and
a key button mechanism, comprising:
a key body having a actuator protruding therefrom; and
a hermetic element being sealingly resisted between the housing and the key body and surrounding the actuator.

7. The electronic device as claimed in claim 6, wherein the hermetic element includes a tubular member, the tubular member has a first end portion and a second end portion that is larger than the first end portion, the first end portion is mounted to the key body, the second end portion is mounted to the housing.

8. The electronic device as claimed in claim 6, wherein each hermetic element further includes a planar board hermetically mounted on the key body, the tubular member surrounds the edge of the planar board.

9. The electronic device as claimed in claim 8, wherein the planar board has a mounting portion with a slot recessed therein; the actuator is accommodating in the slot when the planar board is mounted to the key body.

10. The electronic device as claimed in claim 1, wherein the electronic device further includes a retaining structure which is employed to assist the key body mounting to the housing.

11. The electronic device as claimed in claim 10, wherein the retaining structure includes two spaced-apart troughs defined through the housing, two retaining members carried on the key body extending into the troughs, a distal end of each retaining member is wider than corresponding trough such that the retaining members are retained within the troughs.

12. The electronic device as claimed in claim 6, wherein the housing includes a receptacle recessed from an outer surface thereof, the key body is movably accommodated in the receptacle.

13. An electronic device, comprising:
a housing; and
a key button mechanism, comprising:
a key body movably mounted to the housing, and a gap formed between the housing and the key body; and
a hermetic element mounted between the key body and the housing for sealing the gap between the key body and the housing.

14. The electronic device as claimed in claim 10, wherein the hermetic element includes a tubular member, the tubular member is hermetically resisted between the housing and the key body.

15. The electronic device as claimed in claim 14, wherein the tubular member has a first end portion and a second end portion that is larger than the first end portion, the first end portion is sealingly mounted to the key body, the second end portion is sealingly mounted to the housing.

16. The electronic device as claimed in claim 13, wherein each hermetic element further includes a planar board hermetically mounted on the key body, the tubular member surrounds the edge of the planar board.

17. The electronic device as claimed in claim 16, wherein the planar board has a mounting portion with a slot recessed therein; the actuator is accommodating in the slot when the planar board is mounted to the key body.

18. The electronic device as claimed in claim 13, wherein the electronic device further includes a retaining structure which is employed to assist the key body mounting to the housing.

19. The electronic device as claimed in claim 18, wherein the retaining structure includes two spaced-apart troughs defined through the housing, two retaining members carried on the key body extending into the troughs, a distal end of each retaining member is wider than corresponding trough such that the retaining members are retained within the troughs.

20. The electronic device as claimed in claim 13, wherein the housing includes a receptacle recessed on an outer surface thereof, the key body is movably accommodated in the receptacle.
